(19) United States
(12) Patent Application Publication
(10) Pub. No.: US 2022/0253785 A1
(43) Pub. Date: Aug. 11, 2022

(54) MOBILE MEASUREMENT-ASSESSMENT SYSTEM

(71) Applicant: Atatürk Üniversitesi Rektörlügü Bilimsel Arastirma Projeleri(Bap) Koordinasyon Birimi, Erzurum (TR)

(72) Inventor: Serkan YILDIRIM, Erzurum (TR)

(21) Appl. No.: 17/629,886

(22) PCT Filed: Jun. 9, 2021
(86) PCT No.: PCT/TR2021/050559

§ 371 Date: Jan. 25, 2022

(30) Foreign Application Priority Data
Jun. 12, 2020 (TR) 2020/09127

(51) Int. Cl. G06Q 10/06

(52) U.S. Cl. CPC G06Q 10/06393

(57) ABSTRACT

A mobile measurement assessment system including an application, assignment, placement and result announcement system (BAYS) containing fundamental systems to provide organization of information needed for receiving details of learners to take a test, processing thereof and administering the test, a question preparation system (SHS) providing assignment of subjects and questions to learners, a test application system (SUS) providing administration of prepared tests via mobile devices. The system contains at least one main computer system-containing mobile devices and applications required for performance of test process and providing encrypted wireless communication, at least one mobile tablets and carrying system-providing communication with the main computer system and containing procedures required for learners' login into the test, and a mobile test application containing security systems.

### TECHNICAL FIELD

The invention relates to a mobile measurement-assessment system providing face-to-face and online test administration through mobile devices.

Invention particularly relates to a mobile measurement-assessment system providing more effective assessment of learning outputs of learners, enabling learners to display their skills more clearly and eliminating necessity for using existing communication networks.

### STATE OF THE ART

Learners/students are taken into tests to indicate what they have learnt during all school life. In addition to traditional paper based tests, there are several measurement and assessment systems used in digital environments.

Today one of the most commonly used testing systems is computer based testing system. In this system digital tests are administered in computer test centers specifically prepared for this purpose. Tests are administered with computers via current internet network. Tests are administered to a limited number of test takers (learners) limited to capacity of computer laboratory. In addition to problems occurring in communication network, problems that might occur in energy systems affect all system and result in failure to administer the test.

There are also mobile test systems in use at present. The systems provides test organization via mobile devices. The said systems do not have a communication system specifically assigned for them, and communication channels in common use such as current internet connections are preferred. In addition, these systems are designed on tests level to be conducted at school and broad masses are not targeted.

Application related to the subject is a Chinese patent application numbered CN108154737. The said application discloses a teacher-student-test based system. The said system is for administering school tests at present. In addition it does not disclose an embodiment similar to application system and assigned information system.

Another application related to the subject is a Chinese patent application numbered CN108717674. This application does not disclose a comprehensive mobile test system but more specific subject. In addition, it does not disclose an embodiment similar to a building information system and question preparing system.

As a result, due to above described disadvantages and inadequacy of existing solutions, it has been necessary to make development in the related technical field.

### AIM OF THE INVENTION

The invention has been developed with inspiration from existing situation and aims to eliminate the above mentioned disadvantages.

Primary aim of the invention is to provide a mobile system by offering communication opportunity with its own local network connection in any classroom environment with no impacts from problems caused by current network connections while administering digital tests.

Another aim of the invention is to conduct measurement assessment activities in a safe way by establishing an encrypted communication via mobile devices defined in the system.

A further aim of the invention is to ask questions to learners by multi-media components such as video, audio, visual, animation, simulation in addition to multiple choice questions.

Another aim of the invention is to take answers from learners by means of various alternatives such as option selection, writing, drag, sound recording, video recording, visual drawing, file uploading etc.

A further aim of the invention is to offer web interface systems providing receipt of information to perform test processes such as application, classroom, building, assigned personnel, learner information for preparation of test.

Another purpose of the invention is to cover all of computer and local network systems enabling administration of test via mobile devices at high security level in all classroom environments and establishment of communication with mobile devices during test process in addition to question preparation, test creation, evaluation and announcement systems and specifically all web interfaces of central testing system.

In order to achieve above mentioned aims, the invention comprises application system, building information system, assigned personnel information system, placement system, learner/test taker information system, question preparation system, main computer system, mobile tablets and carrying system, mobile test application.

The structural and characteristics features of the invention and all advantages will be understood better in detailed descriptions with the figures given below and with reference to the figures, and therefore, the assessment should be made taking into account the said figures and detailed explanations.

### BRIEF DESCRIPTION OF THE DRAWINGS

FIG. 1 is a general structure of mobile measurement assessment system of the invention.

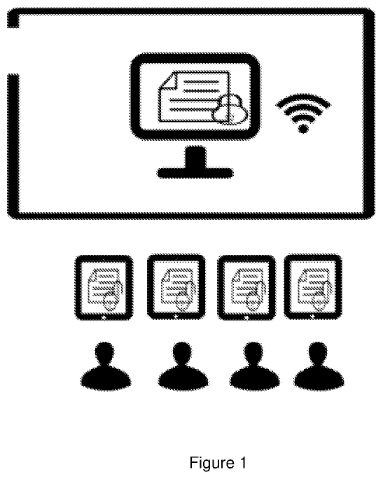

FIG. 2 is a BAYS system structure covered under mobile measurement assessment system of the invention.

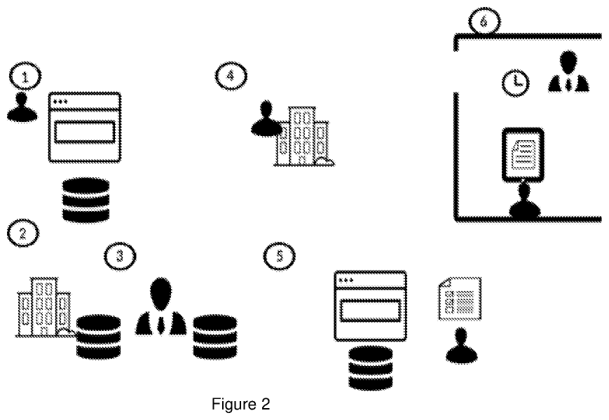

FIG. 3 is a SHS system structure covered under mobile measurement assessment system of the invention.

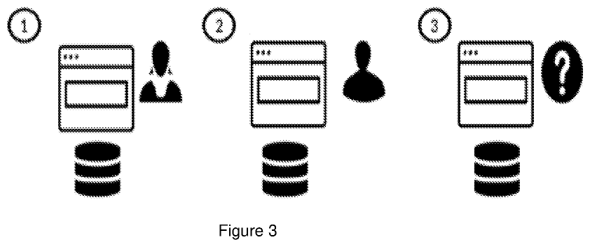

FIG. 4 is a SUS system structure covered under mobile measurement assessment system of the invention.

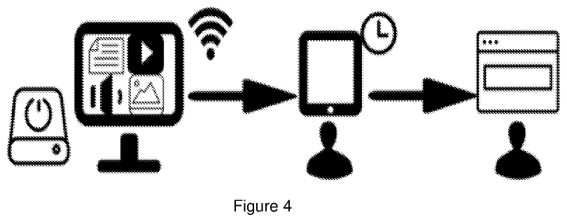

FIG. 5 is a general structure of mobile measurement assessment system of the invention.

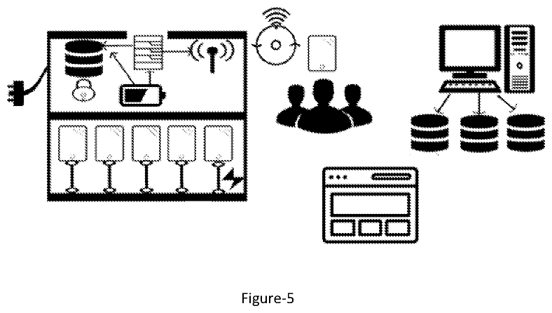

### DESCRIPTION OF PART REFERENCES

1. Application system

2. Building information system

3. Assigned personnel information system

4. Placement system,

5. Learner/test taker informing system,

6. Question preparation system (SHS),

7. Main computer system,

8. Mobile tablets and carrying system,

9. Mobile test application.

### DETAILED DESCRIPTION OF THE INVENTION

In this detailed description, the preferred embodiments of the mobile measurement assessment system being subject of the invention have been described only for purpose of better understanding of the matter.

This invention enables administering test to broad masses via mobile devices without need for any communication and energy sources. With this feature, it eliminates venue limitation and enables administering test to all learners/students simultaneously by adding defined mobile devices to be added to system in the number of learners/test takers to take the test. In respect to system structure, a local network specific to classroom where test will be administered and a main computer system (7) giving information required for administering test are disclosed. One carrying system used per classroom combines communication network and main computer system. Carrying system comprises hardware consisting of communication network needed by mobile devices, computer system providing conduct of test in classroom environment, battery system supplying energy for all devices, energy and data connection points. In addition, carrying system also supply energies of devices to operate energy sources and test system and a full portable system not needing any external power source is provided. Data transmission medium provided in the carrying system can transmit test details to mobile devices or assessment systems via cable or wireless connection. Thus a portable test system fully usable in all intended media can be provided.

Also Mobile test system offer various advantages in comparison to test applications under traditional observation. They are:
Printing process needed in traditional tests is eliminated and thus printing cost, time spent for printing and workforce needed therefore, mistakes in printing and similar negative actions are eliminated and cutting trees for papers to be used are prevented and thus an environmental approach is offered.
Wrong exam documents are eliminated; risk of making mistake in documents to be sent to individuals to take test is reduced and tests needed to be seen by learner/test taker are only sent specifically to the learner/test taker using device and thus document taking risks such as booklet type mistake which is not related to test taker are eliminated.
Supporting questions containing multimedia components, instead of tests under invigilation having only text based questions, students are offered sound, video, 3D drawing, animation, simulation and other multimedia component involving written or visual questions as well as students are given alternative to answer in writing, option selection, audio or visual answers. Headphones to be used in mobile devices for answering questions will enable test taker to listen and answer without disturbing other test takers. With use of different question types, test takers/learners are allowed to display their learning skills at various levels and thus it offers a more effective assessment.
It shortens evaluation process and eliminates process of reading answer keys and transferring them into digital medium and thus offers a fast assessment process and shortens test process. In addition, work force and physical hardware costs needed for assessment are reduced to minimum and thus it is economical.
Offering text based questions and evaluation of standard answers received from learners have provided a listing based approach. This system offers answering allowing indication of alternative skill display supported with multimedia components instead of text based questions and restricted answer giving, and thus possibility of showing real knowledge and skills is increased and a better evaluation process is provided. As a portable system; It eliminates space constraints by enabling digital exams in all kind classroom environments.
Listing of questions in test on number of question basis and distribution of options in answers may change each time and thus each learner can be given a different booklet. This will prevent students from cheating attempts

Mobile test system is a safe test system comprising software and hardware needed to hold test organization via mobile devices in more than one test center, building or test rooms in a safe manner for tests under invigilation. This system comprises software for test preparation and hardware containing computers and tablets for administering test. Mobile test system comprises three main embodiments namely, application, assignment, placement and result announcement system (BAYS) question preparation system (SHS) and test application system (SUS).

Structure and operation of systems are as follows:

Application, Assignment, Placement and Result Announcing System (BAYS): This system comprises fundamental systems to provide organization of information needed for receiving details of learners to take test, processing thereof and administering test. Basic information on structure, features and operation of subsystems contained in BAYS system is as follows;
Application System (1): Application system (1) is an internet based system accessible from web and mobile environments where information of learners to take test is received . It comprising steps and screens required for transfer of test takers' information into mobile test system by learners, teachers or entity to administer test. Allowing entrance of entity based information, this system comprises screens where information on learner's identity, application, options, education level, test subjects or test information can be taken. Information is received into system by applying encryption and stored in encrypted form in mobile test system database.
Building Information System (2): Building information system (2) is the system containing information of building and classrooms of the centres where test will be administered. It contains screens containing information on number of test rooms in the building, room capacities, disable test takers availability levels, technical details such as electric, internet connection, details of physical facilities that will be used by building coordinator and employees. Building information system will be used by test centre coordinator to be assigned for test centre or coordinator to be assigned by entity conducting test.
Employee Information System (3): Employee information system (3) is a web based system comprising screens for conduct of recording, appointment, assignment details of employees to be assigned for the test, submission of test rules and other notifications, submission of assignment certificate and reporting operations upon completion of assignment. The system keeps record of all employees to be assigned for the test (building test coordinator, building test coordinator assistant, building administrator, room administrator, proctor, servant, technical administrator etc.) and defines their responsibilities. Assignment choice selection and appointment for each test will be made in this system. Employees will be appointed in line with positions needed in line with information from placement system (4) and processes on administration of the test are organized from this system.
Placement System (4): Placement system (4) comprises screens for assignment of test takers/learners to test centres selected by them by use of information in building information system (2) and application system (1). Placement of test takers into test rooms is conducted in this system placement and performance of placement operation is organised according to test rules in this system. During placement stage, dynamic placement rules—test time period, test time, venue, etc., measurement and assessment criteria, changes concerning determination of special cases such as disable test taker—are taken into consideration. Information of employees to be needed in the building and rooms to be used upon completion of placement operations are computed and data concerning assignment/appointment of employees from the employee information system (3) are obtained in this system.
Learner/test taker Information System (5): Is the web based system comprising screens for defining student information system tests, conducting test rules information, submission of test entrance documentation and test results announcements. Notices about tests that test takers can take and individual applications can be made in this system. In individual application process, procedures regarding application system (1) and receiving learner information are executed jointly by two systems. In addition, Learner/test taker information system (5) provides delivery of test entrance documents, results and assessment documents for the tests taken by learners. To access, update or print out any document in the system login methods used during system application is verified.

Basically BAYS starts with defining a new test by entity to hold test . After receiving learners' information from application system (1) or learner/test taker informing system (5) subject to test structure, information of building and rooms to be used in test centres are transferred into placement system (4) and test takers are assigned. Employees to be needed as a result of assignment of them, the employees are defined from employee information system (3) and people to be employed are assigned. Following placement, employees receive their assignment certificates from employee information system (3) and learners/test takers access to their test entrance documents from learner informing system (5). After administration of test, employees perform required assessment processes from employee information system (3) and students access to their test results from learner informing system (5). In addition, information about evaluation of test for entities is provided to entities from learner informing system (5).

Question Preparation System (6): This system is an integrated system enabling test question preparation and assignment of subjects and questions to learners based on information received from learner informing system (5). Recording and authorization procedures for testers preparing questions are conducted in question preparation system (6) and testers preparing questions are defined from recorded testers preparing questions and subjects assignment to testers is made. In the system the assigned testers can prepare questions for the subjects they are assigned to. Alternative types of questions and answers such as question text picture, video, 3d drawings, animations, simulations or sound files as the question type requires are prepared and feedback is enabled and explained answer of question can be organized. Different question asking techniques during measurement and assessment process and evaluation type supporting algorithms will be provided. Prepared questions will be labeled according to subject course, subject topic, content, acquisition, difficulty level, distinguishing level. Questions prepared in question preparation system (6) are selected dynamically or by test preparing test based on selection procedure in compliance with test criteria (subject coverage, number of questions, difficulty level etc.) from question system and test/tests or booklets to be used in test are formed. Formed tests or booklets are matched with learners taking subject course in database and subject course assignment to learners is made from question system. Tests can be used for mobile devices as well as allow as web pages or in booklet format allowing use as hard copy if desired so. Distribution of subject courses as per sessions for session based tests is also made automatically by this system or according to present criterias. At final stage tests are brought into form that can be used by test application system (SUS) and thus test preparation process is completed.

Test Application System (SUS): Test application system is the structure providing conduct of prepared tests via mobile devices. Basic components of the structure, features and use processes thereof are as follows:
Main Computer System (7): Main computer has the structure creating medium required for conduct of test, having test questions, providing transfer of questions to mobile devices used in test and recording answers instantly into storing hardware and software provided there on. Main computer is designed as one per each classroom. Main computer can be supplied from power supplies as well as uninterrupted power sources provided in carrying box prepared for main computer. Network components available in main computer enables forming a wireless local network inside test room and other mobile devices used in the test communicate through this network. Thus an encrypted specific to test room allows communication of only test devices via network and unauthorized accesses are prevented. Main computer communicates with active devices of learners and transfers test questions to them before or during testing as per their choice and records answers instantly.
Mobile Tablets and Carrying System (8): Mobile tablets are the devices where learners execute test application and also test officers take roster, records, assignment recording procedures. Processes such as taking roster, individual test cancellation etc. for learners taking test are conducted from mobile tablet used by test room proctor in the test screen prepared for test employees. In addition, arrival and leave tracking of building employees, delivery of mobile test system devices, duty violations and other minutes/records are made from mobile test application (9) in tablet prepared for building test coordinator. Building test coordinator may establish communication via safe network of test system by use of main computer system (7) prepared specifically for building test coordinator by use of mobile tablets. Thus operations pertaining to test processes such as taking attendance of assigned personnel on test day, distribution of mobile test system devices of test rooms, maintaining minutes, preparation of reports are recorded into system instantly. Special carrying systems are available for all mobile tablets used for test employees in the building and power needs of them can be met. Backup devices and authorization systems are also provided for failing devices.
Tablets used by learners in test rooms communicate with main computer system (7) via safe network established by system. For the communication data such as finger print, face recognition, user name and password or test entrance ticket code are used and after verification of learners' identities, only tablets having software containing test system are active. Tablets are active during test duration and after end of test duration or ending test, they are automatically turned off by mobile test application (9).
Mobile test application (9) on the tablets have features of displaying questions, giving answers, changes between questions and tests. In addition, tablets also have pen components for mathematical operations, microphone and headsets for audio questions. Such features are automatically activated or deactivated by the system as per question structure.
Mobile test application (9) has structure to offer giving open ended questions to learners, sending questions with multimedia components such as audio, animation, simulation etc., receiving answers of learners/test takers by various alternatives such as selection, writing, dragging, sound recording, video recording, visual drawing, file uploading etc., storing each answer instantly in itself and main computer system (7) database simultaneously. Application has a security system not allowing test authorization to learners/test takers not appointed to test room upon execution of learner recognition procedures (finger print, face recognition, user name and password and login procedures by means of one of them or more) during operation period.
Mobile tablets are carried to test rooms by mean of carrying system prepared specifically for them. Carrying box of the system has special placement housing for tablets. In addition, charging and data transmission cables are provided in carrying box for each tablet. Thus all tablets are charged via carrying box at the same time and required data sending-receiving processes are performed.

Test Evaluation Process: Mobile test system sends learners' answers to main computer instantly. Evaluation of the results can be made by means of two different approaches. According to instant evaluation approach, evaluation of answers given by learner can be made at main computer upon completion of test and results can be sent to test tablets immediately. In addition, detailed assessment results can be announced via learner informing system (5). In date based evaluation approach, test results are announced on present date, objections and questions from learners are systematically analysed and announced via learned informing system (5). Objections from students in respect to questions are received from learner informing system (5) and required feedback are given via same system individually.

1. A mobile measurement assessment system comprising an application, assignment, placement and result announcement system (BAYS) containing fundamental systems to provide organization of information needed for receiving details of learners to take a test, processing thereof and administering the test, a question preparation system (SHS) providing assignment of subjects and questions to learners, a test application system (SUS) providing administration of prepared tests via mobile devices and characterized by comprising:
at least one main computer system containing mobile devices and applications required for performance of test process and providing encrypted wireless communication;
at least one mobile tablets and carrying system providing communication with the main computer system and containing procedures required for learners' login into the test; and
a mobile test application containing security systems.

2. A mobile measurement assessment system according to claim 1, wherein the mobile test application records answers given by learners during the test into its own system as well as a database on the main computer system simultaneously.

3. A mobile measurement assessment system according to claim 1, wherein the mobile tablets and carrying system g contains communication components capable to execute a procedure to receive and send data from/to devices in the system whenever required.

4. A mobile measurement assessment system according to claim 1, wherein the main computer system can be operated by an available power supply or an internal battery.
